(19) United States
(12) Patent Application Publication
(10) Pub. No.: US 2010/0243656 A1
(43) Pub. Date: Sep. 30, 2010

(54) LINER FOR SIMPLIFYING THE USE OF FLUID SIPHONS

(76) Inventor: Rye NAZARIAN, San Francisco, CA (US)

Correspondence Address: HOGAN LOVELLS US LLP;IP GROUP, COLUMBIA SQUARE, 555 THIRTEENTH STREET, N.W., WASHINGTON, DC, 20004, US

(21) Appl. No.: 12/732,000

(22) Filed: Mar. 25, 2010

Related U.S. Application Data
(60) Provisional application No. 61/163,229, filed on Mar. 25, 2009.

(51) Int. Cl. B65D 25/14; B23P 11/00

(52) U.S. Cl. 220/495.02; 220/23.87; 29/428

(57) ABSTRACT

The invention generally describes a system and method that utilize a liner insert for a supply bucket of a liquid siphoning system, such as a siphon for an airless paint sprayer. The liner is adapted to simply slide into a bucket that corresponds to its size. The liners preferably are disposable, and may be manufactured, such as from plastic, in various sizes and shapes to accommodate different supply bucket and siphon geometries. Each liner insert contains an inner cavity, generally shaped like the inside of a bucket, adapted to receive and hold the fluid to be siphoned. The bottom of the cavity is shaped to cause the fluid to flow into a smaller recess, or “cup,” located at the lowest point of the inner cavity. The bottom inner surface of the liner is sloped toward the cup, and preferably has one or more recessed and sloping channels formed therein to help direct fluid flow toward the cup.

### CROSS-REFERENCE TO RELATED APPLICATIONS

This application claims the benefit of priority of prior co-owned U.S. provisional patent application Ser. No. 61/163,229, filed Mar. 25, 2009.

### FIELD OF THE INVENTION

The present disclosure relates to improvements upon fluid application devices, such as airless paint sprayers, that make use of siphons to remove the fluid from a container, such as buckets. Most particularly, the invention relates to bucket liners used in conjunction with siphoning systems, which bucket liners improve efficiency of the siphon and reduce labor and liquid waste and facilitate cleanup efforts.

### BACKGROUND

Various siphon tools are used throughout various industries to draw fluid from a bucket or other source container and transmit the drawn fluid to another location or otherwise place the fluid under pressure. For example, airless paint sprayers are commonly used by professional painters to apply paints and other surface coatings. Commonly, airless paint sprayers siphon paint from the bottom of a 2 or 5 gallon supply bucket of standard design. The paint taken from the bottom of the supply bucket is drawn via a feed tube into a piston where the paint is then pressurized and forced through a relatively long hose and out through a spray gun directed by the painter. Airless paint spraying systems generally allow the painter to apply the paint (or other spray-on coating) in varying quantities and levels of atomization. Airless paint spraying systems allow painters to treat large areas more quickly than traditional rollers or brushes, and are used extensively in commercial scale applications.

Airless paint spraying systems are not without drawbacks. A particular problem occurs when the amount of paint in the supply bucket becomes too low to keep the end of the siphon intake fully submerged. Once air gets in drawn into the feed tube, and the sprayer can no longer maintain the required amount pressure to continue siphoning and spraying. The painter is left with anywhere from a quart to nearly half a gallon of paint (depending on the viscosity of paint) at the bottom of the bucket. What painters have done in the past to deal with this problem is that whenever the paint is approaching the bottom of the supply bucket, to jerry-rig a way to tilt the bucket and re-submerge the siphon with the remaining paint in order to retrieve the last bit of material from the bottom of the bucket. This is inconvenient, as it often requires the painter to get down off the ladder, scaffolding, or the like, walk over to the bucket, and find a way to prop the bucket securely at an angle. One common and simple approach involves placing a roll of masking tape or a small stack of old paint can lids underneath one side of the supply bucket to tilt it at an angle. Unfortunately, the painter also needs to ensure that the supply bucket will not topple over completely from the weight of the siphon and intake tube, such as by using full cans of paint, boxes, or whatever else is lying around, to buttress the now unstable bucket. Building contractors use similar siphoning systems for the application of various other fluids, and each have similar drawbacks.

One attempt at solving the problem described above is described in U.S. Pat. No. 7,407,063, issued to Rockwell. This patent describes a paint bucket that includes a side wall portion, a bottom portion formed at one end of the side wall portion, and a well region formed in the bottom portion and intended to receive a siphon intake. The bottom portion includes an inclined surface that slopes downward toward the well region such that paint will tend to flow towards and into the well. The bucket described by the Rockwell patent is reusable, being constructed of a heavy durable material, essentially making it an outright replacement for standard paint supply buckets. In particular, the Rockwell bucket is described as bearing a metal handle, and being capable of standing alone while filled during usage, differing from a standard 5 gallon commercial paint supply bucket only in that at its interior bottom surface it has a sloping surface feeding into the well. The Rockwell bucket is not ideal for use in many circumstances. Because the Rockwell bucket is designed to be durable and reusable and capable of being carried while filled with liquid, it is manufactured from a heavy material capable of bearing those stresses. These design requirements inherently limit the design of the well and inner areas when manufacturing costs and ease of cleaning for reuse are accounted for. For example, the well of the Rockwell bucket forms various sharp edges, corners, and cavities which upon reuse can make the bucket difficult to clean following use and thus impede smooth paint flow. This can be especially problematic where additives are added to the paint (or other liquid for siphoning) that make it thicker. Any attempts to employ a more complicated design for the bottom portion of the Rockwell bucket would only exacerbate this problem as it would make the bucket even more difficult to clean sufficiently in a manner that would ensure continued performance of the bucket. Further, the Rockwell bucket cannot be readily and cheaply adapted for use with different particular siphoning systems to optimize performance, leading to the problem that a fairly large amount of paint potentially could be left at the bottom of the bucket.

Other siphoning systems, while used in other industries and/or for applying or transferring liquids for other purposes, likewise suffer from similar drawbacks.

The present invention is directed toward eliminating the problems associated with liquid waste and air entrainment attendant with siphoning systems once the source liquid level becomes low. In the particular embodiments directed toward airless paint sprayers, for example, the invention is directed toward eliminating the necessity to tilt a supply bucket before one is completely out of paint (or other siphoned liquid), toward making use of the paint that might otherwise be left unusable, and toward addressing the drawbacks associated with prior attempts solving the supply bucket problem.

### SUMMARY OF THE INVENTION

Embodiments of the invention include a liner insert that is adapted to simply slide into a supply bucket of corresponding size. Embodiments of the invention could be used for any siphoning system utilizing such a supply bucket where disposability of lines and the attendant ease of cleaning is desirable. However, particularly preferred embodiments of the invention are directed toward liners for supply buckets of airless paint sprayers. Various examples below describe and exemplify the various features of the invention, which include the liner inserts for supply buckets of liquid siphoning systems, liquid siphoning systems utilizing such liner inserts, and methods for siphoning liquids from a supply bucket utilizing such liner inserts.

Once the liner insert is secured inside its host supply bucket, the fluid to be siphoned can be poured in. Notably, paint (or other like siphoning liquids) optionally can be mixed, such as with additive materials, directly within the liner insert, meaning the host supply bucket stays entirely clean.

Each liner insert contains an inner cavity, generally shaped like the inside of a standard bucket (or the shape of the internal cavity of the corresponding supply bucket), adapted to receive and hold the fluid to be siphoned. The bottom of the cavity is shaped to cause the fluid to flow into a smaller recess, or “cup,” located at the lowest point of the inner cavity. Preferably, the cup is located closer toward one sidewall of the liner insert and shaped to receive a siphon intake. The bottom interior surface of the liner insert surrounding the cup is generally sloped toward the cup, and this surface preferably has formed therein one or more recessed and sloping channels arranged to help direct fluid flow toward and into the cup, thus more efficiently directing supply liquid toward siphon intake via gravity while also preventing clogs associated with thicker liquids.

Preferably, the liner insert is manufactured to be disposable, formed from a suitable material that is sufficiently resilient but nonetheless lightweight and relatively cheap. In particular preferred embodiments, the liner insert is injection molded or vacuum formed from a plastic material. Optionally, and preferably, the liner insert could include one or more baffles formed on the outside bottom surface of the liner insert. Such baffles would enable the liner insert to be formed of a sufficiently thin and/or lightweight material while maintaining structural rigidity of the bottom of the liner so as to resist collapse or bursting.

In use, once the paint or other feed liquid has been poured into the liner and bucket assembly, the siphon from the paint sprayer or other like equipment can be placed inside with the siphon intake positioned within the liner insert's cup, and work can begin. As the paint/liquid is drawn from inside the liner insert's internal cavity and the level drops toward the bottom of the liner, the sloped bottom internal surface and optional channels of the internal cavity funnels paint/liquid towards and into the cup where the siphon intake resides. Because the cup is situated at the lowest point of the liner, gravity ensures that all of the paint/liquid is collected there and used without having to tip the bucket.

In certain embodiments of the invention, the liner insert is designed to have an outwardly extending rim at the top of the liner (i.e., around or near its opening) that is adapted to fit, with a certain amount of flexibility, around the upper most lip of the host supply bucket. This helps to maintain the positioning and integrity of the liner insert and enable the liner insert to be formed from a relatively thin and light, and most preferably, disposable, material.

In one alternate embodiment of the liner insert, the outwardly extending rim at the top portion of the liner is not utilized, resulting in an “insert” that does not reach the top of the host bucket but the geometry at the bottom of the “insert” remains the same as the other embodiment of the liner insert as described above. This alternative embodiment of the liner insert can likewise be injection molded or vacuum formed of plastic, but with a flexible rubber-like gasket formed at the top of its upper most rim. The gasket feature prevents paint form seeping underneath it once the insert is pushed into place at the bottom of the host bucket.

In another such alternate embodiment of the liner, the top portion of the liner again lacks the outwardly extending rim. Instead, formed with or affixed to the top of the liner insert is a length of thin flexible film that reaches over the top of the host bucket. This particular alternative embodiment may reduce manufacturing costs and/or be provided accommodate non-standard host bucket sizes, whereby the thin flexible film can be stretched above and/or folded over the upper rim of the host bucket, similar in fashion to how a trash bag is commonly secured within a trash can.

Further, it is commonplace for professional painters to mix their paint with various additives to either modify the surface finish or change flow characteristics of the paint. For example, painters can mix additives into the paint for thinning and leveling purposes. In this regard, in optional preferred embodiments of the invention, printed on the side of the liner insert (e.g., vertically either on the inside or outside surface of the inner cavity) are graduations that allow for measurement.

Also optionally, the word “cup” or other suitable indicia can be printed, embossed, etc., onto a handle or other portion near the top of the liner insert to help the user to identify where the cup is located. This alleviates any difficulty in finding the cup/lowest point once the bucket/liner is filled with an opaque fluid, such as paint.

In other alternate embodiments of the liner, there can be included an integrally-molded clip (such as a C-clip) that accommodates the circumference of the siphon hose and attaches to the rim of the liner. This clip helps hold the length of the siphon upright within the cup.

Further, the systems of the invention can also include a lid, which has a notch in one side and accommodates the siphon entering the bucket liner system. This lid keeps contaminants from getting in the paint, while the notch accommodates the siphon, and/or holds the siphon upright in the cup. The lid can be designed to be disposable, or intended for reuse.

As professional painters typically spray out of 5 or 2 gallon bucket containers, embodiments of the invention adapted for use in spraying paint would comprise liner inserts having sizes such that they would fit appropriately into supply buckets meeting applicable industry-standard sizes. It will be readily appreciated, however, that liner inserts according to the present invention can be manufactured to accommodate any sized supply bucket. It should also be appreciated that different insert liner designs according to the present invention can be cheaply made available that are adapted for use with different paints and/or additives, spraying equipment (e.g., different siphon intake nozzles), supply bucket sizes, and the like, allowing the user to select the appropriate liners optimized for particular uses. With disposable insert liners, the user can cost-effectively optimize the performance of their spray equipment for particular applications while also avoiding the need for messy and extensive cleanup following each use.

In this regard, a first aspect of the invention includes a bucket liner system for use in a siphoning liquid. The system comprises a bucket having an inside surface including a bottom and an open top end with a perimeter rim; and an impervious, non-soluble liner with an open top installable within the bucket by sliding said liner inside the bucket inside the host bucket. The liner has a cup and means for directing fluid to flow into the cup. The cup is sized and shaped to receive a siphon intake, permit fluid flow to the intake, and minimize excess space immediately around the siphon intake.

Further, a second aspect of the invention includes a liner insert adapted to fit within a host bucket for use in a siphoning liquid. The liner insert comprises a generally bucket-like shape having a open top and an inside surface, and a bottom all defining an inner cavity for receiving the siphoning liquid. The liner insert is sized and configured to fit within a standard host bucket by sliding said liner inside the bucket and securing it. The liner insert is disposable and having a cup and means for directing fluid to flow into the cup. The cup is sized and shaped to receive a siphon intake, permit fluid flow to the intake, and minimize excess space immediately around the siphon intake.

Additionally, a third aspect of the invention includes a method for using a system comprising a host bucket, a liner insert, and a siphoning system. The method comprises assembling the system by a inserting said liner insert in said bucket, said liner insert being sized and configured to fit within a standard host bucket by sliding said liner inside the bucket and securing it. The liner is disposable and having an internal cavity that includes a cup and means for directing fluid to flow into the cup. This cup is sized and shaped to receive a siphon intake of said siphoning system, to permit fluid flow to the intake, and to minimize excess space immediately around the siphon intake. The method further includes filling the liner insert with a supply fluid, and inserting a siphon supply tube in said liner. The siphon supply tube terminates in a siphon intake, and this siphon intake is situated within the cup. The cup of said liner is sized and configured to accommodate said siphon intake.

### BRIEF DESCRIPTION OF THE DRAWINGS

The accompanying drawings are included to provide further understanding of the invention and are incorporated in and constitute a part of this specification. The accompanying drawings illustrate exemplary embodiments of the invention and together with the description serve to explain the principles of the invention. In the figures, with like reference numerals used to depict like elements throughout the drawings:

FIG. 1 is an exploded perspective view showing various elements that may be assembled to produce a system according to one embodiment of the present invention.

FIG. 2A is a perspective view of an assembled system formed from the various elements depicted in the embodiment of FIG. 1.

FIG. 2B is an exploded schematic side view depicting an assembled system according to the embodiment of the present invention depicted in FIG. 2A.

FIG. 3 is a top perspective view depicting the liner according to the embodiment of FIG. 2A.

FIG. 4 is a bottom perspective view depicting the liner according to the embodiment of FIG. 2A.

FIG. 5A is a top view depicting the liner according to the embodiment of FIG. 2A.

FIG. 5B is a magnified view of a portion of FIG. 5A depicting a label that may optionally be formed or printed on liners according to the invention.

FIG. 6A is a side profile view of the liner according to the embodiment of FIG. 2A.

FIG. 6B is a bottom view of the liner according to the embodiment of FIG. 2A.

FIG. 7 is a second side profile view of the liner according to the embodiment of FIG. 2A depicting the graduations that optionally may be formed or printed on the side of liners according to embodiments of the invention.

FIG. 8A is a top view of the system according to the embodiment of FIG. 2A.

FIG. 8B is a cross-sectional side view of the according to FIG. 8A shown along the cut-away line C-C of FIG. 8A.

FIG. 9A is a side view of a liner according to an alternative embodiment of the invention.

FIG. 9B is a bottom view of the liner according to the embodiment of FIG. 9A.

FIG. 9C is a second side view of the liner according to the embodiment of FIG. 9A.

FIG. 10A is a side view of a scraper tool according to systems of the present invention.

FIG. 10B is a profile view of the scraper tool according to the embodiment of FIG. 10A.

FIG. 11 is a profile view of a system according to another embodiment of the invention showing usage of the scraper tool depicted in FIG. 10A.

### DETAILED DESCRIPTION OF PREFERRED EMBODIMENTS

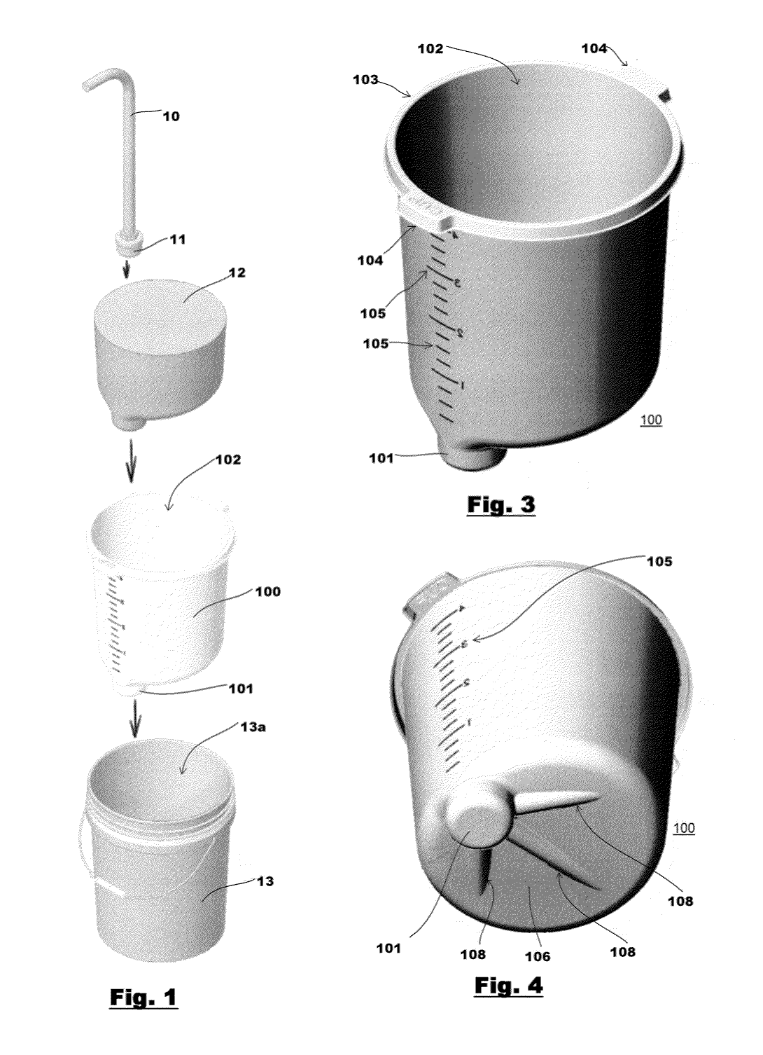

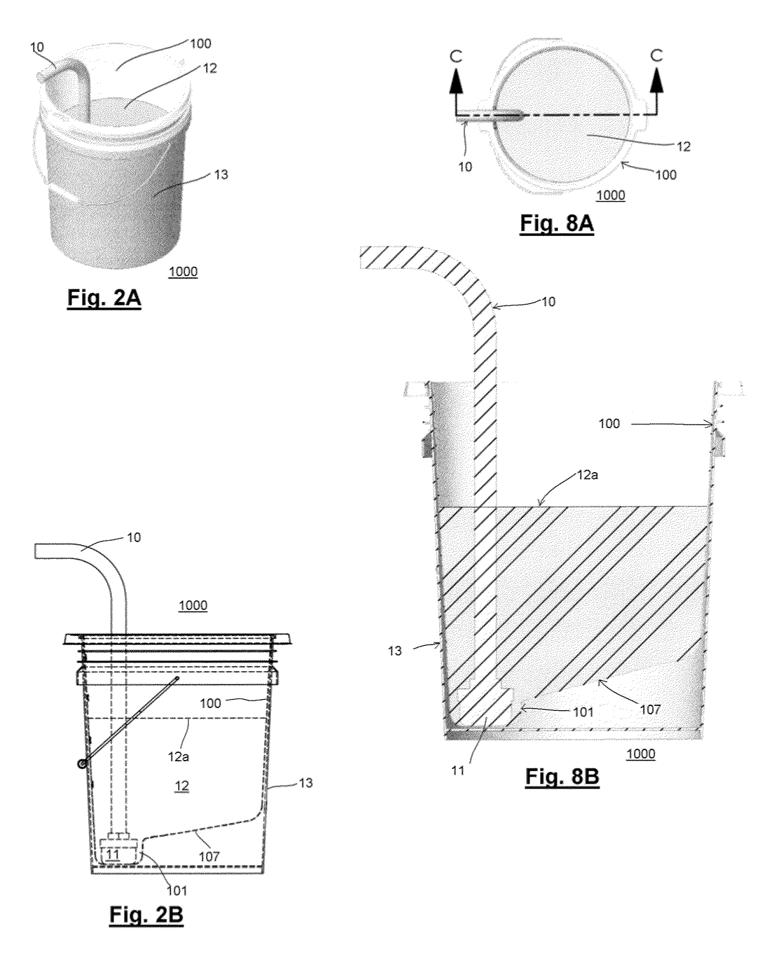

FIG. 1 is an exploded perspective view showing assembly of a system according to one embodiment of the present invention. According to methods of the present invention, an operator obtains a host bucket 13 (such as the normal bucket that the operator would normally use for siphoning purposes) and a suitably sized and shaped liner insert 100 according to the present invention (as described and defined further herein), and inserts the liner insert 100 within the internal cavity 13a of the host bucket 13. The internal cavity 102 of the liner insert 100 is then filled with paint 12 (or other suitable supply liquid). This filling step can optionally, of course, include the mixing of one or more components directly within the liner insert 100 to produce the final desired supply liquid. Finally, the siphon feed line 10 is positioned (the order of adding the paint and siphon can of course be switched). The siphon feed line terminates at its distal end with a siphon intake 11 and connects at its proximal end to the airless paint sprayer or other like equipment (not shown in the drawings) requiring the supply liquid. During positioning, the siphon intake 11 is placed at the bottom of the internal cavity 102 of the liner insert 100 within the recessed cup 101. Optionally, the siphon feed line 10 can be secured in place with an integral C-clamp or other feature formed in the liner insert 100, as described in further detail below. Completion of this method thereby assembles a siphoning system 1000 according to embodiments of the present invention, as shown in the elevational view of FIG. 2A and the side view of FIG. 2B (which uses hashed lines to depict internal elements). Thereafter, drawing of supply liquid from within the liner insert 100 can begin.

In use, as the paint 12 or other liquid is drawn from within the internal cavity 102 and the fluid level 12a drops toward the bottom of the internal cavity 102, the sloping surface 107 and optional channels 108 formed in the bottom internal surface forming the internal cavity (as described in further detail below) collectively or individually serve as means for directing fluid into the cup 101 as they in essence funnel paint/liquid towards and into the cup 101 where the siphon intake 11 resides. Because the cup 101 is situated at the lowest point of the liner insert 100, gravity and the shape of the bottom of the internal cavity 102 ensures that all of the paint/liquid flows into and is collected in the cup 101 and used without having to tip the bucket as the level 12a drops and approaches the siphon intake 11. Typically, as shown in FIG. 2A, the cup 101 should be optimally sized to be slightly larger than the end of the nozzle for the siphon intake 11 (e.g., brand of airless paint sprayer) that will be used.

Turning now to FIG. 3, there is depicted in top perspective view a preferred embodiment of a liner insert 100 according to the present invention. As shown, the liner insert 100 is generally shaped like a bucket, having cylindrical sidewalls, a base connected to the sidewalls, and an opening near the top, thus forming internal cavity 102. The liner insert 100 preferably is integrally formed of plastic, such as via an injection molding or vacuum forming process. It also has an outwardly extending rim 103 located along its upper edge of the sidewalls, which rim 103 serves for holding the liner securely within the appropriately sized host bucket (not shown in this drawing). Optionally, as shown, the rim 103 can include two opposing portions 104 that jut out and serve as handles for the user to grasp and insert/remove the liner insert 100, when necessary. The cup 101 is also depicted at the bottom of the liner 100, and measuring indicia 105 is preferably printed or otherwise formed on the interior surface of liner's sidewalls as shown to assist in mixing.

FIG. 4 is a perspective view of the same liner insert 100 as FIG. 3, but showing it from underneath. Again, the outwardly extending rim 103 and opposing portions 104 are visible, and it can be more easily seen how the rim 103 of the liner 100 would slip over the corresponding upper lip of the host supply bucket. This feature, as described above, helps provide stability once the weight of the paint is added to the bucket liner system, and thus serves the function of securing the liner insert 100 to the host bucket. As shown in FIG. 4, the cup 101 is integrally formed in the base 106 of the liner insert 100 so as to form the lowest point of the internal cavity 102. The base 106 is further configured such that bottom surface forming the internal cavity around the cup 101 is generally sloped toward the cup. Preferably, the cup 101 is located closer toward one sidewall of the liner insert (as shown) and sized and shaped to receive a siphon intake and allow fluid flow to the intake while minimizing the chances of air entrainment. The bottom interior surface of the liner insert surrounding the cup 101 can be sloped or curved in any manner such that gravity directs liquid into the cup 101.

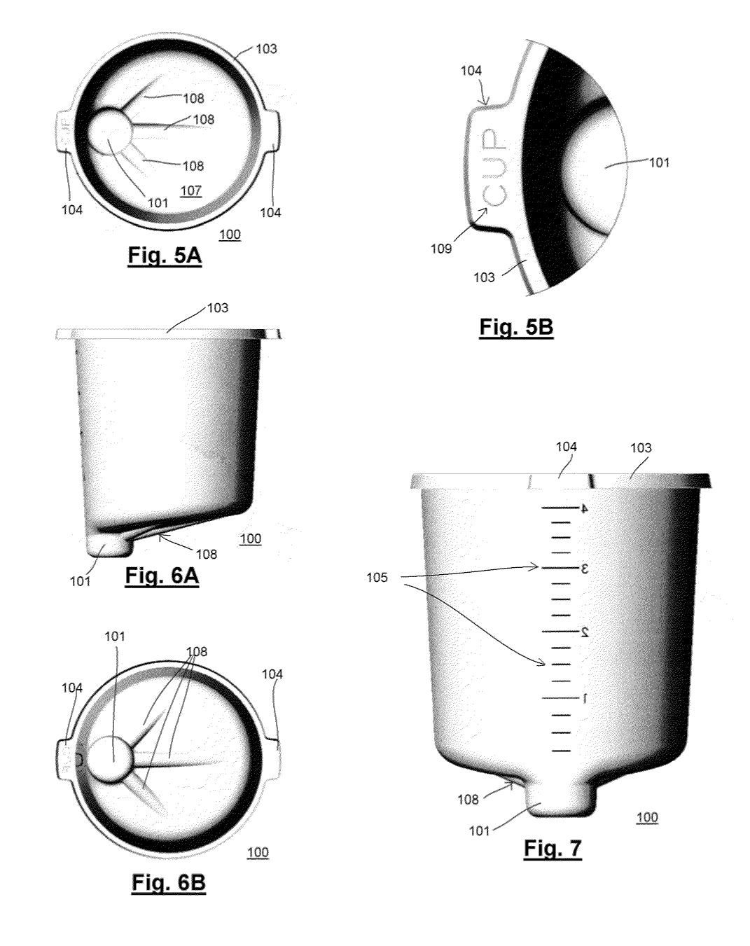

As shown collectively in FIG. 6A and FIG. 7, which also show different views of the same embodiment of the liner insert 100 depicted in FIG. 3, the cup 101 preferably is formed off center (i.e., towards one of the sidewalls) and is surrounded by a frustoconically shaped internal sloping surface 107 that directs fluid flow toward and into the cup 101 via gravity, similar in manner to a funnel. This internal sloping surface 107 also preferably has formed therein one or more recessed and sloping channels 108 arranged to help direct supply liquid more efficiently toward the cup 101 and siphon intake 11 via gravity while also preventing clumping or clogs that may be associated with thicker liquids.

FIG. 5A in particular provides a top view of the same liner insert 100. From this view, an operator would be able to see within the internal cavity 102 and thus the bottom internal surface of the liner insert 100. In this view, it can be seen that the cup 101 is located off center and generally surrounded by a sloping surface 107. Various channels 108, arranged here in a spoke pattern radiating from the cup 101, aid in funneling the paint/fluid into the cup. Because in this particular embodiment the cup 101 is the only portion of the liner insert 100 that would sit on the bottom of the host bucket 13, these channels 108 also aid in structural reinforcement of the liner insert.

FIG. 5A, and the corresponding bottom view of FIG. 6B, show the arrangement of the opposing portions 104 on the outwardly extending rim 103 of the liner insert 100. Not only can the opposing portions 104 operate as handles, but one or more of the opposing portions (or, alternatively, the rim) can be embossed with or carry printed thereon a mark or other indicia identifying where the off center cup 101 is located. FIG. 5B in particular provides a blown up view of a portion of the liner insert view of FIG. 5A, where it can be seen that the word “cup” is embossed into the handle (i.e., outwardly extending portion 104), and this serves as an indicia 109 regarding the location of the off center cup 101 that can be seen even when the internal cavity 102 of the liner insert is holding an opaque liquid. Such handles, of course, also may also be used together allow for removing and installing the liner into and out of the host bucket.

As shown by comparison of the different side views of liner insert 100 provided by FIG. 6A and FIG. 7, the bottom surface of the liner insert 100 preferably takes a particularly suitable frustoconical geometry. As indicated in these drawings, the bottom surface (understanding that the outwardly-visible bottom surface in this embodiment follows the shape and form of the internal surface) is graded in a manner that directs all fluid towards the integrated cup 101 that resides at the lowest point in the liner, while the channels 108 help to direct fluid into the cup from various portions of the inner cavity. As depicted, it is preferred that internal edges of the internal cavity (i.e., where the sloping surface 107, the liner sidewalls, cup 101, and channels 108) are rounded to avoid collection points. Further, FIG. 7 depicts the measurement indicia 105 printed and/or embossed on the internal sidewalls of the liner that facilitate measurements and mixing of fluid directly within the liner.

FIG. 8B provides is a sectioned view (sectioned along the line C-C shown in FIG. 8A) showing how the liner insert 100 holds the paint 12 (or other siphon supply fluid) and prevents it from touching the host bucket 13. The fluid is indicated by the diagonal hash marks in this cutaway perspective. Note how the fluid resides in relation to the geometry of the liner insert 100, the host bucket 13, and the siphon tube 10.

In the embodiment of the liner insert 100 described above, there is an outwardly extending rim 103 at the top of the liner 100 sidewalls (i.e., around or near its opening) that is adapted to fit, with a certain amount of flexibility, around the upper most lip of the host supply bucket 13. This serves as a means for securing the top of the liner insert to the host bucket 13. However, in alternative embodiments of the invention, the top of the sidewalls of the liner insert do not have such a rim, but rather alternative structures may serve as means for securing the top of the liner insert to the host bucket.

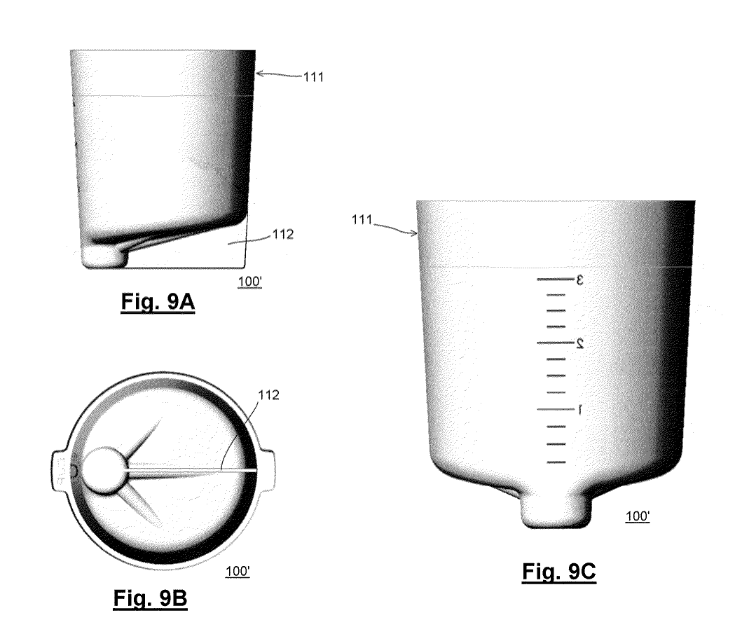

One such alternate embodiment is the liner insert 100′ depicted in FIGS. 9A-9C. As shown, an outwardly extending rim at the top portion of liner insert 100′ is not utilized. In one version of this alternative embodiment, the top of the liner insert can be designed such that it does not reach the top of the host bucket. This could, for example, leave the geometry at the bottom of the “insert” essentially the same as the other embodiment of the liner insert 100 as described above. This alternative embodiment of the liner insert 100′ can likewise be injection molded or vacuum formed of plastic, but this time the sidewalls are formed with a flexible portion 111 at the top of the liner insert 100′. In a version where the liner insert 100′ is designed to not reach the top of the host bucket, the flexible portion could serve as a rubber-like gasket formed at the top of its upper most rim. The gasket frictionally engages in the inner sidewalls of the host supply bucket so as to fit securely and also prevent paint form seeping underneath it once the insert is pushed into place at the bottom of the host bucket.

In a second version of this alternate embodiment of the liner 100′, the flexible portion 111 at the top of the liner insert 100′ is formed to be a length of thin flexible film that extends a sufficient length upward to reach over the top of the host bucket. This particular alternative embodiment may reduce manufacturing costs and/or be provided accommodate non-standard host bucket sizes, whereby the thin flexible film can be stretched above and/or folded over the upper rim of the host bucket, similar in fashion to how a trash bag is commonly secured within a trash can.

Also, it should be noted that the embodiment of the liner insert 100′ depicted in FIGS. 9A-9C depicts a baffle 112 that may optionally be formed along the bottom of any liner insert according to the present invention. One or more of such baffles 112 may be used to provide additional structural rigidity to the liner insert and help support the weight of the contained fluid within the supply bucket. Since liner inserts according to most preferred embodiments of the present invention are intended to be disposable after one or a few uses, it is preferable that they be made of a thin and lightweight material to reduce waste and costs. However, as the liner insert is made more lightweight and thin, tradeoffs of decreased strength and stability are encountered. One or more baffles 112 as depicted can help to maintain the positioning and integrity of the liner insert and enable the liner insert to be formed from a relatively thin and light, and most preferably, disposable, material. Such baffles, for example, may be particularly important in embodiments of the invention lacking an outwardly extending rim. If multiple baffles are utilized, they may be formed on the bottom outside surface of the liner insert in, for example, a spoke pattern radiating outward from the cup, or in a crisscross or honeycomb pattern.

In other alternate embodiments of the liner insert, there can be included an integrally-molded clip (such as a C-clip) that accommodates the circumference of the siphon hose and attaches to the rim of the liner. This clip helps hold the length of the siphon upright and maintain the siphon intake seated within the cup.

Since professional painters typically spray out of 5 or 2 gallon bucket containers, embodiments of the invention adapted for use in spraying paint would comprise liner inserts having sizes such that they would fit appropriately into supply buckets meeting applicable industry-standard sizes. It will be readily appreciated, however, that liner inserts according to the present invention can be manufactured to accommodate any sized supply bucket. It should also be appreciated that different insert liner designs according to the present invention can be cheaply made available that are adapted for use with different paints and/or additives, spraying equipment (e.g., different siphon intake nozzles), supply bucket sizes, and the like, allowing the user to select the appropriate liners optimized for particular uses. With disposable insert liners, the user can cost-effectively optimize the performance of their spray equipment for particular applications while also avoiding the need for messy and extensive cleanup following each use.

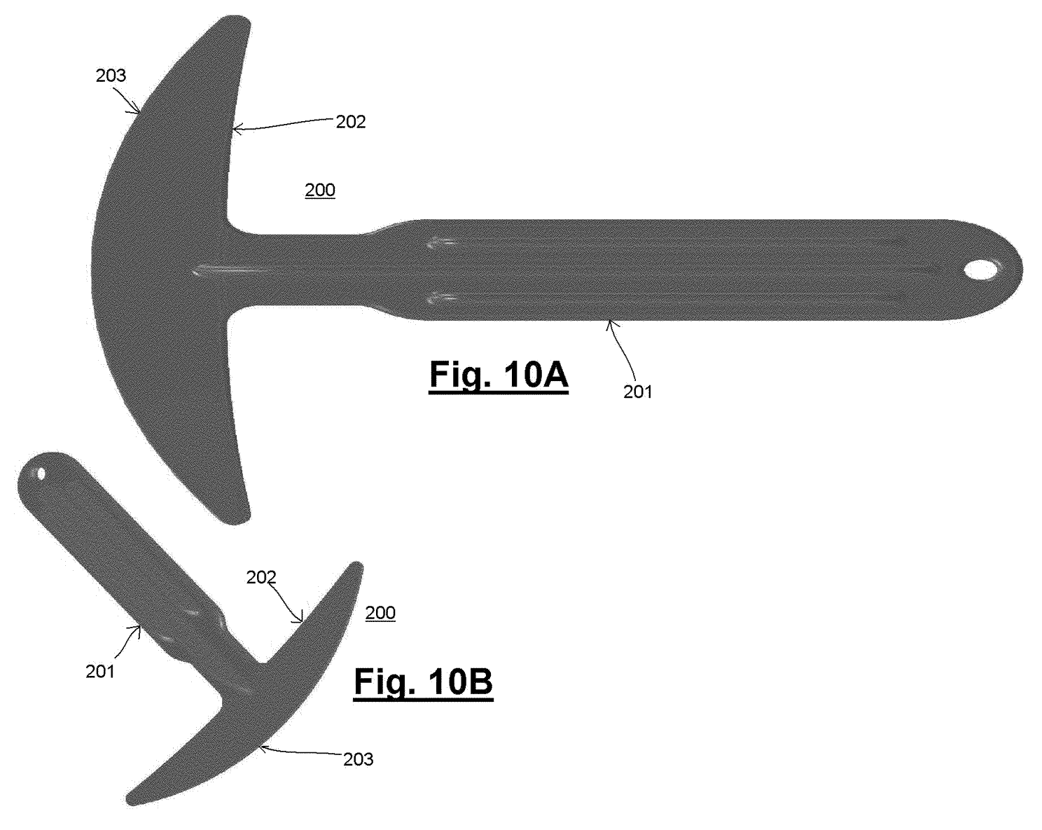

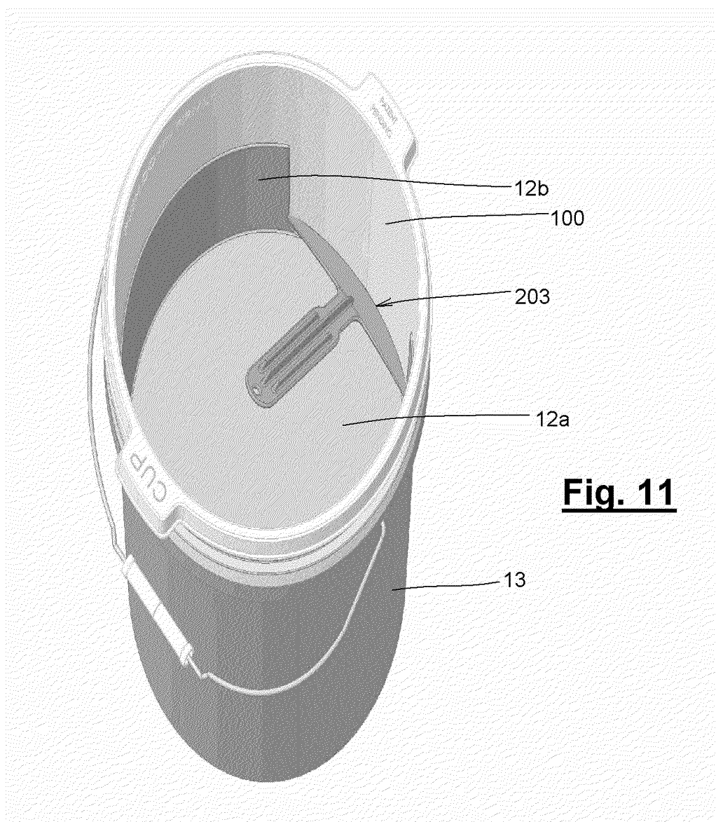

Siphoning systems according to the present invention such as the system 1000 depicted in FIG. 2A can optionally include a scraper tool 200 as depicted in FIGS. 10A and 10B. As shown in those drawings, the scraper tool includes a handle 201 terminating at its distal end in a scraping blade 202. The blade 202 is formed having a edge 203 shaped to fit against the internal surfaces of the liner insert sidewalls and permit the operator to “scrape down” the supply fluid at intervals (or, alternatively, clean the liner insert). The handle is of a length sufficient to fit within the internal cavity. As shown in FIG. 11, the scraper tool 200 can fit easily within the internal cavity of liner insert 100 and used to scrape down paint 12b (or other supply fluid) that sticks to the sidewall of the liner insert 100 as the paint level drops. The scraper tool 200 can be sold separately, or, preferably, packaged in combination with one or more of the liner inserts at the point of sale. Optionally, the scraper tool can be integrally produced with the liner insert of plastic, such as via injection molding or vacuum forming, such that, for example, the handle of the scraper tool is attached to the rim of the liner insert (such as by a small scored bridge of plastic) in a manner such that the tool can be easily detached from the liner insert rim prior to use.

Further, the systems of the invention can also include a lid, which has a notch or hold in one side sized to accommodate the siphon feed line 10 entering the bucket and liner insert. This lid would typically be disk-like in shape, and essentially be similar in design and shape to a standard round plastic trash can lid, with the notable exception of a U-shaped opening or notch formed on one side. The notch would of course be designed to be situated above the cup when set atop the liner insert and host bucket assembly, and provides an opening for accommodating the siphon tube. The lid thereby keeps contaminants from getting in the paint, while the notch accommodates the siphon while simultaneously holding the siphon upright in the cup. The lid can be designed to be disposable, or intended for reuse. It also can be integrally formed with and/or detachable from the liner insert similar in manner to the scraper tool described above.

The preferred embodiments having thus been described, those skilled in the art will readily appreciate that various modifications and variations can be made to the above described preferred embodiments without departing from the spirit and scope of the invention. The invention thus will only be limited to the claims.

We claim:

1. A bucket liner system for use in a siphoning liquid, said system comprising:
a bucket having an inside surface including a bottom and an open top end with a perimeter rim; and
an impervious, non-soluble liner with an open top installable within the bucket by sliding said liner inside the bucket inside the host bucket, said liner having a cup and means for directing fluid to flow into the cup, said cup being sized and shaped to receive a siphon intake, permit fluid flow to the intake, and minimize excess space immediately around the siphon intake.

2. The bucket liner system of claim 1, wherein the means for directing comprises a bottom of the liner, said bottom being sloped in a manner that funnels all fluid to a cup situated at the lowest point of the bucket insert allowing for fluid collection.

3. The bucket liner system of claim 2, wherein said cup has a substantially cylindrical shape and is located towards a sidewall of said liner, and said means for directing comprises a bottom interior surface of the liner substantially surrounding said cup, said bottom interior surface being sloped in a manner that directs fluid to flow into the cup via gravity.

4. The bucket liner system of claim 3, wherein said bottom interior surface assumes a substantially frustoconical shape.

5. The bucket liner system of claim 3, wherein the means for directing further comprises at least one sloping channel formed in a bottom interior surface of said liner bottom of the liner substantially surrounding said cup, said bottom being sloped in a manner that directs fluid to flow into the cup via gravity.

6. The bucket liner system of claim 2, wherein said cup has a substantially cylindrical shape and is located towards a sidewall of said liner, and said the means for directing comprises a bottom interior surface of the liner substantially surrounding said cup, said bottom interior surface having at least one sloping channel formed therein and terminating at said cup, said channel being sloped in a manner that directs fluid to flow into the cup via gravity.

7. The bucket liner system of claim 1 wherein the liner is formed from a plastic material.

8. The bucket liner system of claim 7, wherein said liner is disposable.

9. The bucket liner system of claim 1, further comprising a scraper tool adapted to fit within said liner and having a blade shaped to accommodate inner sidewalls of said liner.

10. The bucket liner system of claim 1, further comprising a lid having a U-shaped notch, said lid adapted to fit securely over said liner, and said notch being adapted to be situated over said cup and allow a siphon intake hose to pass through said lid.

11. A liner insert adapted to fit within a host bucket for use in a siphoning liquid, said insert comprising:
a generally bucket-like shape having a open top and an inside surface, and a bottom all defining an inner cavity for receiving the siphoning liquid; and
said liner insert being sized and configured to fit within a standard host bucket by sliding said liner inside the bucket and securing it, said liner being disposable and having a cup and means for directing fluid to flow into the cup, said cup being sized and shaped to receive a siphon intake, permit fluid flow to the intake, and minimize excess space immediately around the siphon intake.

12. The liner insert of claim 11, wherein the means for directing comprises a bottom interior surface of the liner insert, said bottom interior surface being sloped in a manner that funnels all fluid to a cup situated at the lowest point of the liner insert allowing for fluid collection.

13. The liner insert of claim 12, wherein said cup has a substantially cylindrical shape and is located towards a sidewall of said liner insert, and said means for directing comprises a bottom interior surface of the liner insert substantially surrounding said cup, said bottom interior surface being sloped in a manner that directs fluid to flow into the cup via gravity.

14. The liner insert of claim 13, wherein said bottom interior surface assumes a substantially frustoconical shape.

15. The liner insert of claim 13, wherein the means for directing further comprises at least one sloping channel formed in a bottom interior surface of said bottom interior surface of the liner insert substantially surrounding said cup, said bottom interior surface being sloped in a manner that directs fluid to flow into the cup via gravity.

16. The liner insert of claim 12, wherein said cup has a substantially cylindrical shape and is located towards a sidewall of said liner insert, and said the means for directing comprises a bottom interior surface of the liner substantially surrounding said cup, said bottom interior surface having at least one sloping channel formed therein and terminating at said cup, said channel being sloped in a manner that directs fluid to flow into the cup via gravity.

17. The bucket liner system of claim 11 wherein, the liner is formed from a plastic material.

18. A method for using a system comprising a host bucket, a liner insert, and a siphoning system, said method comprising:
assembling said system by a inserting said liner insert in said bucket, said liner insert being sized and configured to fit within a standard host bucket by sliding said liner inside the bucket and securing it, said liner being disposable and having an internal cavity that includes a cup and means for directing fluid to flow into the cup, said cup being sized and shaped to receive a siphon intake of said siphoning system, to permit fluid flow to the intake, and to minimize excess space immediately around the siphon intake;
filling said liner insert with a supply fluid;
inserting a siphon supply tube in said liner, said siphon supply tube terminating in a siphon intake, and said siphon intake being situated within said cup;
wherein said cup of said liner is sized and configured to accommodate said siphon intake.

19. The method according to claim 18, wherein said liner insert is secured within said host bucket by a means for securing integrally formed in said liner insert.

20. The method according to claim 18, further comprising siphoning at least a portion of said supply fluid from liner insert, and then disposing of said liner insert.
